(19) United States
(12) Patent Application Publication
(10) Pub. No.: US 2023/0291054 A1
(43) Pub. Date: Sep. 14, 2023

(54) RECHARGEABLE BATTERY PACK

(71) Applicant: Hilti Aktiengesellschaft, Schaan (LI)

(72) Inventors: Moses ENDER, Buchs (CH); Matthias LEPIORZ, Chemnitz (DE); Klaus HAUSER, Schwabmunchen (DE); Nora MARTINY, Herrsching-Breitbrunn (DE); Robert STANGER, Kaufbeuren (DE); Bernd ZIEGLER, Schabmunchen (DE); Kathrin SAX, Scheuring (DE)

(21) Appl. No.: 18/017,733

(22) PCT Filed: Jul. 15, 2021
(86) PCT No.: PCT/EP2021/069796

§ 371 Date: Jan. 24, 2023

(30) Foreign Application Priority Data
Jul. 27, 2020 (EP) 20187811.3

(51) Int. Cl. H01M 50/262; H01M 10/48; H01M 50/211

(52) U.S. Cl. CPC H01M 50/262; H01M 10/488; H01M 50/211; H01M 2220/30

(57) ABSTRACT

A rechargeable battery pack which is designed to be detachably received in a receiving bay of an electric handheld power tool and/or a charging station, wherein the rechargeable battery pack has at least one rechargeable battery cell which is arranged within a housing of the rechargeable battery pack, wherein the rechargeable battery pack has a mechanical lock with a release position and a locked position, wherein the mechanical lock is designed to prevent the rechargeable battery pack from being received in the receiving bay in the locked position, and wherein the mechanical lock is tripped by an increase in volume of the rechargeable battery cell.

The present invention relates to a rechargeable battery pack which is designed to be detachably received in a receiving bay of an electric handheld power tool and/or of a charging station. The rechargeable battery pack has at least at least one rechargeable battery cell which is arranged within a housing of the rechargeable battery pack. Rechargeable battery packs of this kind are known in principle from the prior art. The phenomenon of what is known as swelling, also referred to as expansion, is likewise known from the prior art. This is problematic because it can lead to an outer shell of the rechargeable battery cell bursting open. As a result, the rechargeable battery pack itself or its electronics may in turn be damaged, which may result in a risk to the user.

### BACKGROUND

European patent application EP 3 591 739 A1 describes a rechargeable battery pack having a pouch cell, wherein the rechargeable battery pack has at least one circuit breaker which is designed to at least temporarily interrupt a current draw from the pouch cell, wherein the circuit breaker is tripped by expansion of the pouch cell.

### SUMMARY OF THE INVENTION

It is an object of the present invention to provide an alternatively configured rechargeable battery pack that provides the basis for increased operational reliability.

The present invention provides that the rechargeable battery pack has a mechanical lock with a release position and a locked position, wherein the mechanical lock is designed to prevent the rechargeable battery pack from being received in the receiving bay in the locked position, and wherein the mechanical lock is tripped by an increase in volume of the rechargeable battery cell.

The invention includes the finding that a defective rechargeable battery pack of the prior art—in which, for example, an electrical circuit breaker is provided—can typically only be identified due to a lack of functioning of the electric handheld power tool. The rechargeable battery pack according to the invention, however, has a mechanical lock, so that a defective rechargeable battery pack can be “haptically” identified by the fact that it can no longer be inserted into the receiving bay of an electric handheld power tool and/or of a charging station. The advantage of the present invention is, in particular, that the mechanical lock itself does not have to be supplied with electrical energy. Accordingly, the mechanical lock also functions if any electronics in the rechargeable battery pack are damaged or inactive for other reasons.

In a particularly preferred refinement, the housing has a mechanical interface via which the rechargeable battery pack can be received in the receiving bay. It has been found to be advantageous if the mechanical lock is arranged at the mechanical interface. In a particularly preferred refinement, the mechanical interface is designed as a connection bar. The rechargeable battery pack can advantageously be pushed by means of the connection bar onto a receiving unit which corresponds to the connection bar and which is arranged in the receiving bay of the electric handheld power tool and/or of the charging station.

In a further preferred refinement, the mechanical lock has a bolt. It has been found to be advantageous if the bolt is preloaded into the release position by a spring element of the mechanical lock. In a further preferred refinement, the spring element is arranged in such a way that a preloading of the spring element can be overcome by the expanding rechargeable battery cell. It has been found to be advantageous if the bolt is arranged on the connection bar of the rechargeable battery pack. In a particularly preferred refinement, when the mechanical lock is in the locked position, the bar is locked directly by the bolt. As an alternative or in addition, the bolt or an additional bolt can be arranged at a distance from the connection bar of the rechargeable battery pack.

It has been found to be advantageous if the mechanical lock has a mechanical indicator element. The indicator element can signal the malfunctioning of the rechargeable battery pack (swollen rechargeable battery cell) to a user. In a particularly preferred refinement, the indicator element is provided in the form of a colored material section. In a further particularly preferred refinement, the indicator element is provided on the bolt of the mechanical lock in the form of a material section of the bolt that is colored differently from the bolt. For example, the bolt can comprise a black-colored plastic, wherein the indicator element that is formed integrally with the bolt can be provided in the form of a red-colored plastic section.

In a further preferred refinement, the rechargeable battery pack has a detent which is designed to prevent manual operation of the mechanical lock from the locked position into the release position. The detent has the advantage that an unintentional “activation” of the defective rechargeable battery pack is prevented or at least made considerably more difficult.

In a further preferred refinement, the rechargeable battery pack has a latching delay element which, when the rechargeable battery cell is expanded, is designed to hold the mechanical lock in the release position until the rechargeable battery pack is removed from the receiving bay. This renders it possible for a defective rechargeable battery pack to still be able to be removed from the receiving bay of the electric handheld power tool before the mechanical lock effectively jumps into the locked position.

It has been found to be advantageous if the mechanical lock is different from any manual locking mechanism provided on the rechargeable battery pack. In a further preferred refinement, the rechargeable battery pack has, in addition to the mechanical lock which is preferably not manually operable by a user, a manual locking mechanism which, in particular, prevents the rechargeable battery pack from sliding out of the receiving bay of the electric handheld power tool and/or of the charging station in an undesired manner.

In a particularly preferred refinement, the rechargeable battery cell is designed as a pouch cell. It has been found to be advantageous if the rechargeable battery pack has a plurality of pouch cells that are stacked in a sandwich-like manner in the stacking direction. It has been found to be advantageous if the bolt and/or the spring element is in direct contact with the rechargeable battery cell and/or is mechanically operated by it.

### BRIEF DESCRIPTION OF THE DRAWINGS

Further advantages will become apparent from the following description of the figures. Various exemplary embodiments of the present invention are illustrated in the figures. The figures, the description and the claims contain numerous features in combination. A person skilled in the art will expediently also consider the features individually and combine them to form useful further combinations.

In the figures, identical and similar components are denoted by the same reference signs. In the drawings:

FIG. 1A shows a first preferred exemplary embodiment of a rechargeable battery pack according to the invention with a mechanical lock in a release position;

FIG. 1B shows the first preferred exemplary embodiment of the rechargeable battery pack according to the invention with the mechanical lock in a locked position; and

FIG. 2 shows an electric handheld power tool of the prior art.

### DETAILED DESCRIPTION

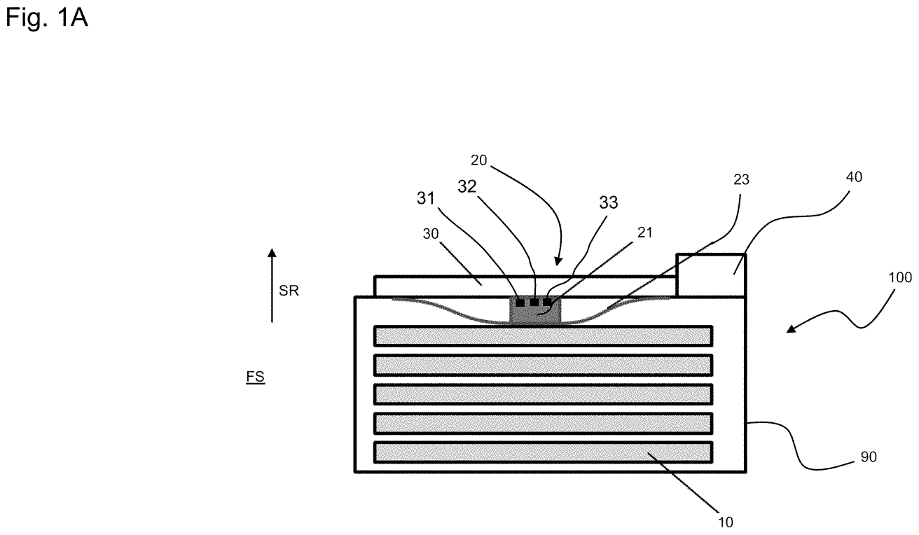

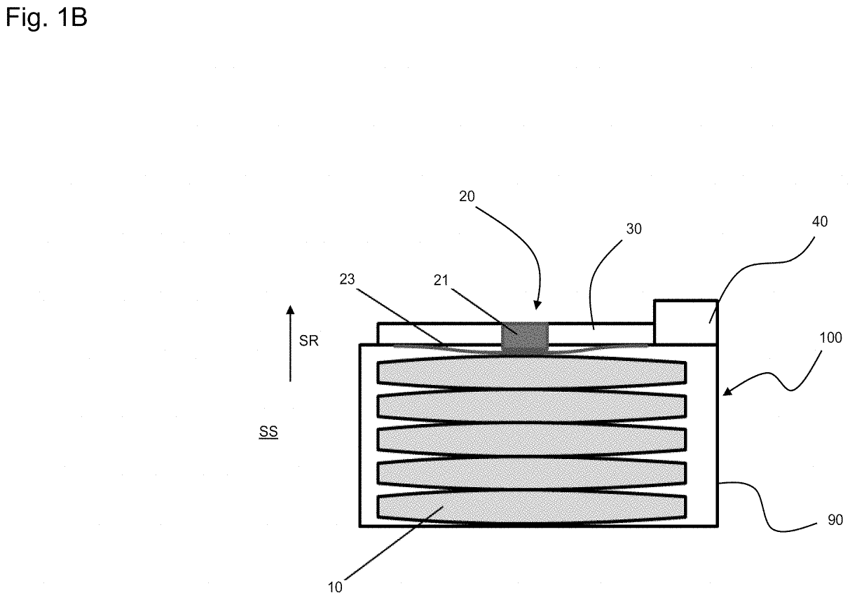

A preferred exemplary embodiment of a rechargeable battery pack 100 according to the invention is illustrated in FIG. 1. The rechargeable battery pack 100 has at least one rechargeable battery cell 10 which is arranged within a housing 90 of the rechargeable battery pack 100. In the exemplary embodiment illustrated here, the rechargeable battery cell 10 is designed as a pouch cell. More precisely, five rechargeable battery cells 10, which are stacked in a sandwich-like manner in the stacking direction SR and provided as pouch cells, are arranged within the housing 90.

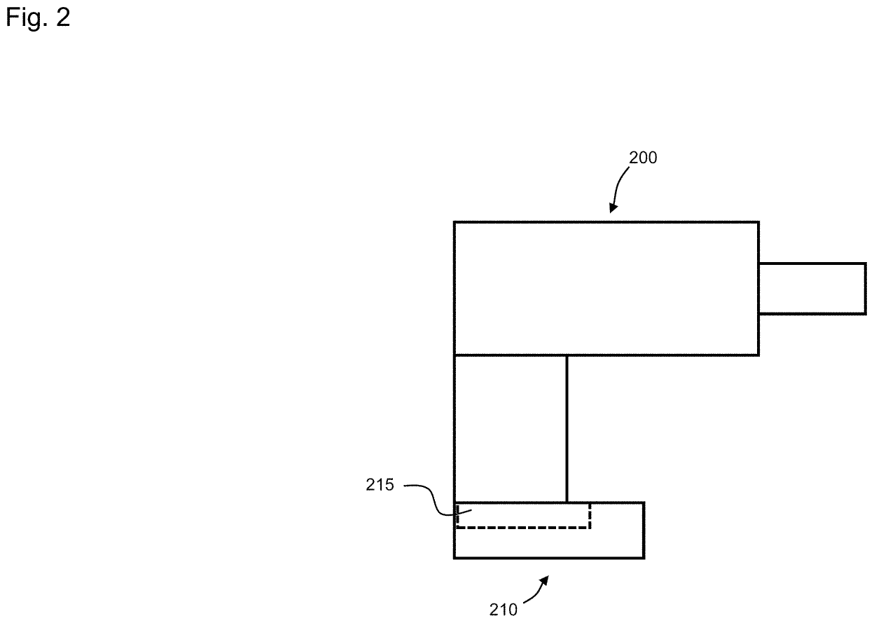

The rechargeable battery pack 100 is designed to be detachably received in a receiving bay 210 of an electric handheld power tool 200 (cf. FIG. 2), wherein this is ensured by a mechanical interface 30 which is arranged on the housing 90. In the exemplary embodiment in FIG. 1, the mechanical interface 30 is designed, by way of example, as a connection bar, by means of which the rechargeable battery pack 100 can be pushed onto a receiving unit 215 which corresponds to the connection bar and which is arranged in the receiving bay 210 of the electric handheld power tool 200. The rechargeable battery pack 100 likewise has an electrical interface 40 in the form of a contact block, via which the rechargeable battery pack 100 can be electrically connected to the handheld power tool 200 in order to supply it with electrical energy.

According to the invention, the rechargeable battery pack 100 has a mechanical lock 20 with a release position FS (cf. FIG. 1A) and a locked position SS (cf. FIG. 1B). The mechanical lock 20 is designed to prevent the rechargeable battery pack 100 from being received in the receiving bay 210 in the locking position SS. According to the invention, the mechanical lock 20 is tripped by an increase in volume of the rechargeable battery cells 10. This is explained in more detail below.

As can be seen from FIG. 1A, the mechanical lock 20 has a bolt 21 which is preloaded into the release position FS by a spring element 23 in the form of a leaf spring. Here, the mechanical lock 20 is arranged, for example, directly at the mechanical interface 30 in the form of the connection bar. The connection bar is not blocked by the bolt 21 since the bolt 21 is located completely (or at least predominantly) within the housing 90 of the rechargeable battery pack. The spring element 23 in the form of the leaf spring presses the bolt 21 against the topmost rechargeable battery cell 10, which is in the normal state, i.e. is not swollen.

During the course of cell aging, there is an increase in volume of the rechargeable battery cells 10, this being illustrated in FIG. 1B. The rechargeable battery cells 10 are expanded in the stacking direction SR. The preloading of the spring element 23 is overcome in this way, as a result of which the bolt 21 is pressed into the mechanical interface 30, which is provided as a connection bar, in the stacking direction SR. The connection bar is therefore blocked by the bolt 21 since the bolt 21 is located completely (or at least predominantly) within the mechanical interface 30, which is provided as a connection bar. Accordingly, the rechargeable battery pack 100 can no longer be pushed onto the receiving unit 215 which corresponds to the connection bar and which is arranged in the receiving bay 210 of the electric handheld power tool 200. Advantageously, the mechanical lock 20 itself does not have to be supplied with electrical energy, as a result of which increased operational reliability of the rechargeable battery pack 100 is achieved.

As shown solely schematically in FIG. 1A with respect to above discussed elements, a detent 31, and indicator 32 and a latching delay 33 can also be provided.

### LIST OF REFERENCE SIGNS

10 Rechargeable battery cell
20 Mechanical lock
21 Bolt
23 Spring element
30 Mechanical interface
31 detent
32 indicator
33 latching delay
40 Electrical interface
90 Housing
100 Rechargeable battery pack
200 Electric handheld power tool
210 Receiving bay
215 Receiving unit
FS Release position
SS Locking position
SR Stacking direction

1-10. (canceled)

11. A rechargeable battery pack designed to be detachably received in a receiving bay of an electric handheld power tool or a charging station, the rechargeable battery pack comprising:
at least one rechargeable battery cell arranged within a housing of the rechargeable battery pack; and
a mechanical lock with a release position and a locked position, the mechanical lock being designed to prevent the rechargeable battery pack from being received in the receiving bay in the locked position, the mechanical lock being tripped by an increase in volume of the rechargeable battery cell.

12. The rechargeable battery pack as recited in claim 11 wherein the housing has a mechanical interface, the rechargeable battery pack receivable in the receiving bay via the mechanical interface, the mechanical lock being arranged at the mechanical interface.

13. The rechargeable battery pack as recited in claim 11 wherein the mechanical interface is designed as a connection bar.

14. The rechargeable battery pack as recited in claim 11 wherein the mechanical lock has a bolt preloaded into the release position by a spring.

15. The rechargeable battery pack as recited in claim 14 wherein the spring is arranged in such a way that a preloading of the spring is overcomeable by an expanding rechargeable battery cell.

16. The rechargeable battery pack as recited in claim 11 wherein the mechanical lock has a mechanical indicator.

17. The rechargeable battery pack as recited in claim 11 wherein the mechanical indicator is in the form of a colored material section.

18. The rechargeable battery pack as recited in claim 11 further comprising a detent designed to prevent manual operation of the mechanical lock into the release position.

19. The rechargeable battery pack as recited in claim 11 further comprising a latching delay designed, when the rechargeable battery cell is expanded, to hold the mechanical lock in the release position until the rechargeable battery pack is removed from the receiving bay.

20. The rechargeable battery pack as recited in claim 11 wherein the mechanical lock is different from any manual locking mechanism provided on the rechargeable battery pack.

21. The rechargeable battery pack as recited in claim 1 wherein the rechargeable battery cell is designed as a pouch cell.
